(19) United States
(12) Patent Application Publication
(10) Pub. No.: US 2013/0278772 A1
(43) Pub. Date: Oct. 24, 2013

(54) RUNNING INFORMATION RECORDING DEVICE FOR HEAVY CONSTRUCTION EQUIPMENT

(71) Applicant: Gi Jung Yun, Incheon (KR)

(72) Inventor: Gi Jung Yun, Incheon (KR)

(73) Assignee: DOOSAN INFRACORE CO., LTD., Incheon (KR)

(21) Appl. No.: 13/979,081

(22) PCT Filed: Jan. 18, 2012
(86) PCT No.: PCT/KR2012/000442

§ 371 Date: Jul. 10, 2013

(30) Foreign Application Priority Data
Jan. 24, 2011 (KR) 10-2011-0007068

(51) Int. Cl. H04N 7/18

(52) U.S. Cl. CPC H04N 7/18
USPC 348/148

(57) ABSTRACT

A running information recording device for heavy construction equipment of the present disclosure includes a plurality of cameras installed on the side surfaces of a unit of heavy construction equipment to gather image data about the area around the unit of heavy construction equipment; an image processor generating the image data about the area around the unit of heavy construction equipment; and a memory storing the image data, and the image data includes a synthetic moving image in which an image of the unit of heavy construction equipment is positioned in the middle, and the image data acquired from the plurality of cameras is synthesized into a single image to be displayed such that the area around the unit of heavy construction equipment is shown in bird's eye view.

### CROSS-REFERENCE TO RELATED APPLICATION

This Application is a Section 371 National Stage Application of International Application No. PCT/KR2012/000442, filed Jan. 18, 2012 and published, not in English, as WO2012/102513 on Aug. 2, 2012.

### FIELD OF THE DISCLOSURE

The present disclosure relates to a running information recording device for heavy construction equipment, and more particularly, to a running information recording device that synthesizes image data about the area around a vehicle, vehicle position information, and a running operation status into a single image datum, records the synthesized image data, and displays the recorded data on a screen, in order to, when an accident occurs while operating heavy construction equipment, objectively and accurately verify a cause of the accident.

### BACKGROUND OF THE DISCLOSURE

In recent years, a concern about a vehicular black box similar to a black box mounted on an airplane has increased and a technology for various vehicular black boxes has been proposed.

When an automobile traffic accident occurs, an automobile accident recording device, that is, an automobile black box is a device that records information associated with automobile travelling and driver operating information so as to analyze or reconfigure the accident.

When the accident occurs, the automobile accident recording device detects the accident, and records and stores an internal vehicle situation, an external situation, an accident time, running information, and image and audio information associated therewith until a predetermined time from a predetermined time before the accident occurs or from the time when the accident occurs.

Since the automobile accident recording device may be of big help in investigating the cause of the accident and preventing the accident, the automobile accident recording device has been recommended at a national level.

For example, the U.S. recommends mounting an accident recording device in vehicles that have been manufactured from 2008, EU has also legislated obligatory mounting an accident recording device from 2009, while China is also scheduled to obligate mounting a digital travelling recording device. In particular, Japan has already utilized a vehicular image black box, which is one type of black box, already mounted in a taxi, a truck, a bus, or the like.

In Korea, the Korean Agency for Technology and Standards by the Ministry of Commerce has enacted and published the Korean Industrial Standard for the Automobile Accident Recording Device on Nov. 8, 2007, and presently, an accident recording device (digital running recording meter) has been attached to a commercial vehicle such as a taxi, a bus, a truck, or the like since 2010.

However, in the related art, since the running information recording device suitable for the unit of heavy construction equipment has not been proposed, when an accident occurs while the heavy construction equipment vehicle is operated, there is a problem in that a cause of the accident cannot be properly determined and various data gathered while the heavy construction equipment vehicle is operated cannot be used at all.

Since the automobile accident recording device in the related art allows operation related data acquired while operating the vehicle from various devices (for example, a GPS system, various sensors including front and rear cameras, and the like) capable of acquiring external information correspondingly provided, which is provided without informatization of the running related data, there is a problem in that a lot of data which can assist in a safe operation cannot be used.

The discussion above is merely provided for general background information and is not intended to be used as an aid in determining the scope of the claimed subject matter.

### SUMMARY

This summary and the abstract are provided to introduce a selection of concepts in a simplified form that are further described below in the Detailed Description. The summary and the abstract are not intended to identify key features or essential features of the claimed subject matter, nor are they intended to be used as an aid in determining the scope of the claimed subject matter.

An embodiment of the present disclosure is contrived to consider an actual state in the related art and an object of the present disclosure is to provide a running information recording device for heavy construction equipment that, when an accident occurs while a heavy construction equipment vehicle is being operated or working, can objectively and accurately verify a cause thereof and achieve a safe operation.

A running information recording device for heavy construction equipment of the present disclosure for achieving the object includes a plurality of cameras installed in a heavy construction equipment vehicle to gather image data; a vehicle control apparatus capable of acquiring operational information of the heavy construction equipment vehicle; an image processor generating a synthetic moving image through various pieces of information input through the camera and the vehicle control apparatus; a monitor capable of displaying the synthetic moving image of the image processor; an image encoder capable of encoding the synthetic moving image of the image processor; and a memory capable of storing image information encoded through the image encoder, and the image processor acquires user input data from the vehicle control apparatus in order to display a control status of the vehicle by a user, converts the acquired user input data into a visual format image, and uses left and right joystick instruction values, and an RPM dial input value as the user input data.

The running information recording device for heavy construction equipment of the present disclosure may be configured in such a manner that all of five cameras are installed at a rear side, and both front sides and both rear sides of the heavy construction equipment vehicle to monitor surroundings of the vehicle.

In the running information recording device for heavy construction equipment of the present disclosure, the vehicle control apparatus acquires operation status information of the vehicle, processes the acquired data as data of a type, which is possible to visually recognize, in order to display the acquired data which is included in the image data, converts digital data, analog data, and various sensor input values of the unit of heavy construction equipment into meaningful values by a predetermined equation, and processes a maximum reaching distance, a height, an angle of a boom, and angles of the boom and an arm of the unit of heavy construction equipment as a visual screen by calculating the maximum reaching distance, the height, the angle of the boom, and the angles of the boom and the arm of the unit of heavy construction equipment.

In the running information recording device for heavy construction equipment of the present disclosure, the memory may be constituted by two spaces of a space for storing a synthetic image displayed in real time and a space for permanent data storage, and when an event is generated from the vehicle control apparatus, the image processor may store image data in the permanent storage data area of the memory.

Meanwhile, in the running information recording device for heavy construction equipment of the present disclosure, a moving image screen, which are synthesized into one by the image processor, may be configured in a type in which a heavy construction equipment image is positioned in the middle and the data acquired from the camera is displayed around the unit of heavy construction equipment.

Further, the moving image screen, which is synthesized into one by the image processor, may be configured in a type in which GPS data is positioned at an upper left end of the screen, positional information of the unit of heavy construction equipment acquired from the vehicle control apparatus is displayed at an upper right end of the screen, a joystick input operated by a user is displayed at a lower middle, RPM information and primary equipment data are displayed at a lower left end, and vehicle digital data is simply displayed at lower right end of the screen as a bit.

According to a running information recording device of heavy construction equipment of the present disclosure, when an accident or a failure occurs while a heavy construction equipment vehicle is in operation or is working, it is possible to objectively and accurately verify a cause of the accident or the failure through image data stored in a memory.

Moreover, image data about the area around a vehicle and positional information of the vehicle, and a driving operation status can be verified through an image screen of a monitor while the unit of heavy construction equipment is run, and as a result, it is possible to obtain an effect of achieving safe running of the heavy construction equipment vehicle.

### DESCRIPTION OF THE DRAWINGS

FIG. 1 is a configuration block diagram according to an exemplary embodiment of the present disclosure.

FIG. 2 is a camera installation status diagram according to the exemplary embodiment.

FIG. 3 is an exemplary diagram of a monitor display screen according to the exemplary embodiment.

### DESCRIPTION OF MAIN REFERENCE NUMERALS OF DRAWINGS

10: Camera
20: Microphone
30: Vehicle control apparatus
40: GPS receiver
50: Shock sensor
60: Image processor
70: Monitor
80: Image encoder
90: Memory
210: Working system operating apparatus
220: Travel system operating apparatus
230: RPM setting operation apparatus

### DETAILED DESCRIPTION

A detailed technological content of the present disclosure for achieving the object will be described below in detail with reference to the accompanying drawings.

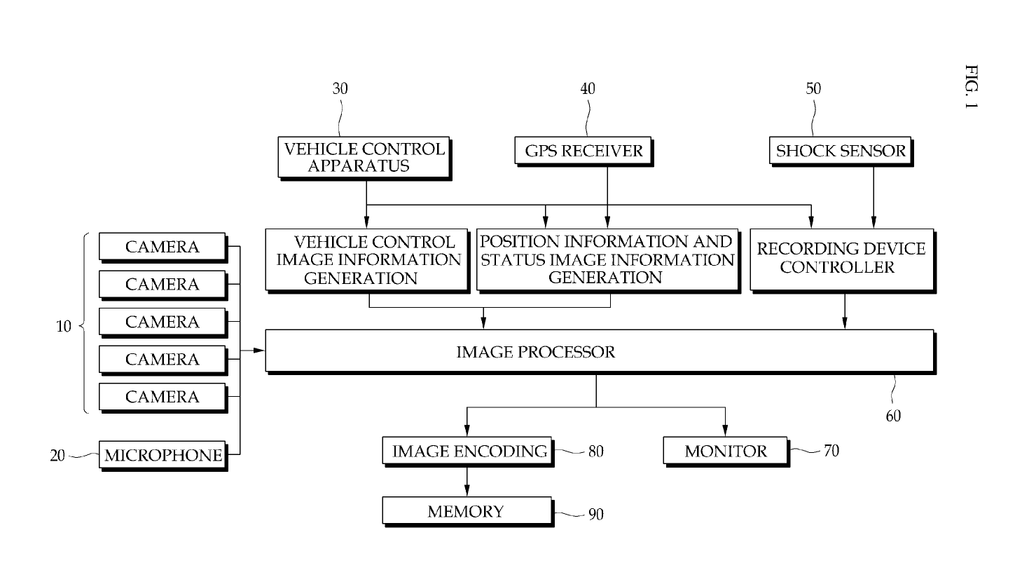

FIG. 1 illustrates a configuration block diagram according to an exemplary embodiment of the present disclosure.

As illustrated in FIG. 1, a running information recording device for heavy construction equipment of the present disclosure includes: a plurality of cameras 10 installed in a heavy construction equipment vehicle 100 to gather image data; a vehicle control apparatus 30 capable of acquiring operational information of the heavy construction equipment vehicle 100; an image processor 60 generating a synthetic moving image through various pieces of information input through the camera 10 and the vehicle control apparatus 30; a monitor 70 installed in a driving room so as to display the synthetic moving image of the image processor 60; an image encoder 80 capable of encoding the synthetic moving image of the image processor 60; and a memory 90 capable of storing image information encoded through the image encoder 80.

Like the illustrated exemplary embodiment, the running information recording device for heavy construction equipment of the present disclosure may further include a microphone 20 installed in the heavy construction equipment vehicle 100 to gather audio data; a GPS receiver 40 capable of acquiring positional information and time information of the heavy construction equipment vehicle 100; and a shock sensor 50 capable of sensing a shock on the heavy construction equipment vehicle 100.

The unit of heavy construction equipment includes an operating apparatus 200 provided to input a user's operation signal for working or travelling. The operating apparatus 200 may include a working system operating apparatus 210, such as a joystick, or the like, for controlling an operating apparatus of the unit of heavy construction equipment such as a boom, an arm, a bucket, an upper swing body, or the like, a travel system operating apparatus 220, such as a pedal, a steering wheel, or the like, for travelling control of the unit of heavy construction equipment, and an RPM setting operation apparatus 230 for setting an RPM of an engine.

Operational amount information of the operating apparatus is input into the image processor 60 through the vehicle control apparatus 30, or the like. As a result, in the synthetic moving image, shapes of the operating apparatuses 210, 220, and 230 are displayed as visualized operating apparatus images and when the operating apparatuses are operated, a change in the operation apparatus image corresponding to a variation in operational amount thereof is preferably displayed to be visually verified.

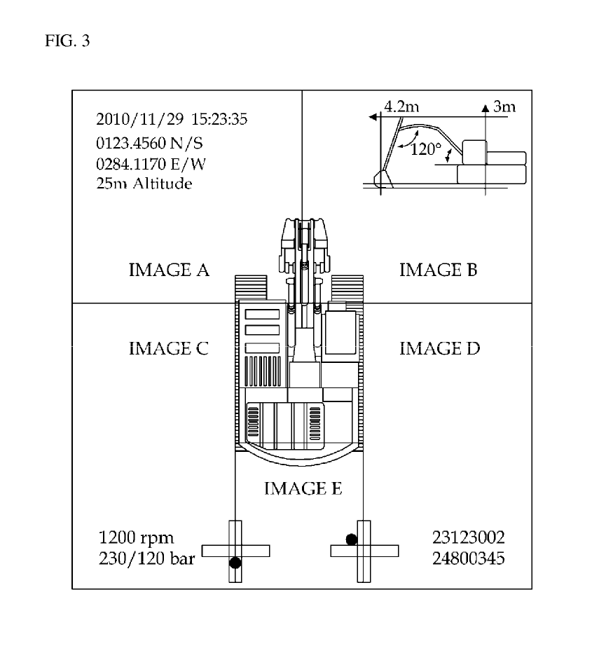

FIG. 3 illustrates a joystick which is one type of working system operating apparatus 210 and is symbolized as a cross shape at a lower end of the synthetic moving image and illustrates one example in which a point P is synthesized with the synthetic moving image so as to move to correspond to a user's operation therein. Further, although not illustrated, operations of other operating apparatuses may be synthesized with the moving image similarly as described above. For example, the travel system operating apparatus 220 may be displayed in the synthetic moving image as a pedal-shaped image and the image may be changed to correspond to an operational amount thereof.

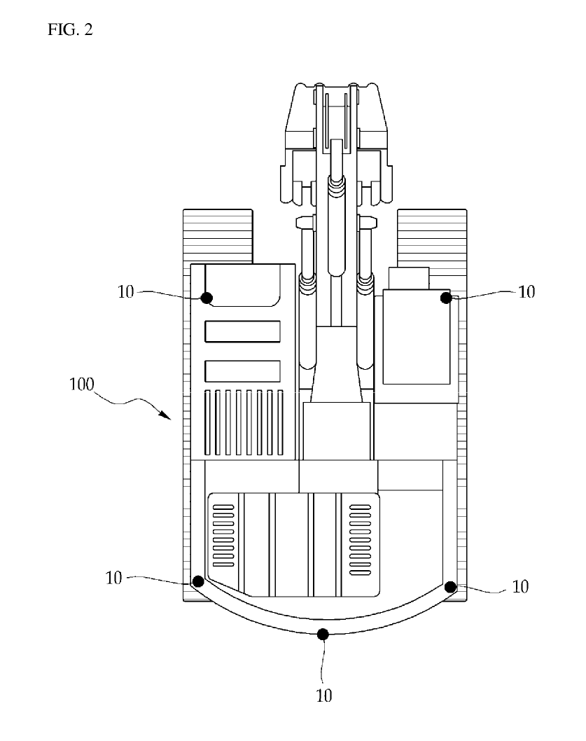

FIG. 2 illustrates a camera installation state diagram according to the exemplary embodiment.

In the illustrated exemplary embodiment, all of five cameras 10 are installed at a rear side, and both front sides and both rear sides of the heavy construction equipment vehicle 100 to monitor surroundings of the vehicle as illustrated in FIG. 2. Therefore, the number of cameras 10 and installation positions of the cameras 10 are not limited to the illustrated number and installation positions of the cameras 10, but may be modified to the expectable number and installation positions of the cameras in the running information recording device for heavy construction equipment of the present disclosure.

In the running information recording device for heavy construction equipment of the present disclosure, the camera 10 is used to monitor the surroundings of the vehicle and acquires image data about the area around the vehicle and synthesizes the image data acquired through the camera 10 into a single image similarly to a surrounding environment of the vehicle to display a surrounding status of the vehicle.

In the running information recording device for heavy construction equipment of the present disclosure, the vehicle control apparatus 30 acquires operation status information of the vehicle, processes the acquired data as a data type, which is possible to visually recognize, in order to display the acquired data which is included in the image data, converts digital data, analog data, and various sensor input values of the unit of heavy construction equipment into meaningful values by a predetermined equation, and processes postures of the unit of heavy construction equipment and the operating apparatuses of the unit of heavy construction equipment as a visual screen by calculating a maximum reaching distance, a height, an angle of a boom, and angles of the boom and an arm of the unit of heavy construction equipment. Of course, data such as a distance, a height, an angle, and the like used for calculating the posture of the unit of heavy construction equipment are preferably processed to be displayed together with the visual screen.

The image processor 60 acquires user input data input through the vehicle control apparatus 30, or the like in order to display a control status of the vehicle by a user, converts the acquired user input data into a visual format image, and uses left and right joystick instruction values, and an RPM dial input value as the user input data.

The image processor 60 converts a surrounding image, and positional and status information of the equipment, which are acquired, as one moving image and sequentially stores the image-converted data in the memory 90 through the image encoder 80 while displaying the image-converted data to the user through the monitor 70.

When a control status of the vehicle is rapidly changed or a shock is sensed from the shock sensor, the vehicle control apparatus 30 generates an event to the image processor 60.

Meanwhile, in the running information recording device for heavy construction equipment of the present disclosure, the memory 90 may be divided into two areas to store the synthetic moving image.

That is, one space is used as an area storing a synthetic image displayed in real time and the area is an area which is erased by being overwritten by a recent image sequentially in an old order.

The other area is used for permanent data storage, and when the event is generated from the vehicle control apparatus 30, the image processor 60 stores image data of the first 10 minutes in a permanent storage data area.

FIG. 3 illustrates an exemplary diagram of a monitor display screen of the exemplary embodiment.

As illustrated in FIG. 3, in the running information recording device for heavy construction equipment of the present disclosure, a moving image screen, which is synthesized into one by the image processor 60, may be configured in such a manner that a heavy construction equipment image is positioned in the middle and data acquired from the camera is displayed around the unit of heavy construction equipment.

The screen may be configured in such a manner that GPS data is positioned at an upper left end of the screen, a time, a latitude, a longitude, and an altitude are displayed, and the positional information of the unit of heavy construction equipment acquired from the vehicle control apparatus 30 is displayed at an upper right end of the screen.

In addition, the moving image screen, which is synthesized into one by the image processor 60, may be configured in such a manner that an operating apparatus input operated by the user is displayed at a lower middle, RPM information and primary equipment data are displayed at a lower left end, and vehicle digital data is simply displayed at a lower right end of the screen as a bit.

The present disclosure described as above is not limited to the above description and it will be apparent to those skilled in the art that various substitutions, transformations, and changes can be made within the scope without departing from the spirit of the preset disclosure.

The present disclosure may be used in a running information recording device that synthesizes image data about the area around a vehicle and positional information of the vehicle, and a driving operate status into a single image datum, records and displays, on a screen, the image datum.

Although the present disclosure has been described with reference to exemplary and preferred embodiments, workers skilled in the art will recognize that changes may be made in form and detail without departing from the spirit and scope of the disclosure.

1. A running information recording device for heavy construction equipment, comprising:
a plurality of cameras installed on the side surfaces of a unit of heavy construction equipment to gather image data about the area around the unit of heavy construction equipment;
an image processor generating the image data about the area around the unit of heavy construction equipment; and
a memory configured to store the image data,
wherein the image data includes a synthetic moving image in which an image of the unit of heavy construction equipment is positioned in the middle, and the image data acquired from the plurality of cameras is synthesized into a single image to be displayed such that the area around the unit of heavy construction equipment is shown in bird's eye view.

2. The running information recording device for heavy construction equipment of claim 1, further comprising:
an operating apparatus outputting user input data corresponding to a user's operation for driving the unit of heavy construction equipment,
wherein the image processor is configured to acquire the user input data input from the operating apparatus by a user, convert the operating apparatus outputting the user input data into a visual-type operating apparatus image, and synthesize the operating apparatus image with the synthetic moving image while changing the operating apparatus image to correspond to a change in an operational amount of the operating apparatus by the user's operation.

3. A running information recording device for heavy construction equipment, comprising:
a plurality of cameras installed in a unit of heavy construction equipment to gather image data about the area around the unit of heavy construction equipment;
an operating apparatus configured to output user input data corresponding to a user's operation for driving the unit of heavy construction equipment;
an image processor configured to generate a synthetic moving image in which the image data about the area around the unit of heavy construction equipment and operation information of the operating apparatus are synthesized with each other; and
a memory configured to store the synthetic moving image,
wherein the image processor is configured to acquire the user input data input from the operating apparatus by a user, convert the operating apparatus outputting the user input data into a visual-type image, and synthesize the image with the image data about the area around the unit of heavy construction equipment while changing the image to correspond to a change in an operational amount of the operating apparatus by the user's operation to generate the synthetic moving image.

4. The running information recording device for heavy construction equipment of claim 3, further comprising:
a vehicle control apparatus,
wherein the vehicle control apparatus is configured to acquire an operation status of the heavy construction equipment vehicle, process the acquired data as a data type, which is possible to visually recognize, in order to display the acquired data which is included in the image data, and process posture information of the unit of heavy construction equipment and an operating apparatus of the unit of heavy construction equipment as a visual screen based on digital data, analog data, and various sensor input values of the unit of heavy construction equipment.

5. The running information recording device for heavy construction equipment of claim 4, wherein:
the posture information of the unit of heavy construction equipment and the operating apparatus of the unit of heavy construction equipment further includes the heights, distances, and angle information of the operating apparatuses of the unit of heavy construction equipment.

6. The running information recording device for heavy construction equipment of claim 3, wherein:
the memory includes two areas of an area for storing a synthetic moving image displayed in real time and an area for permanent data storage, and
when an event is generated in the unit of heavy construction equipment, image data of the synthetic moving image is stored in the permanent storage data area of the memory.

7. The running information recording device for heavy construction equipment of claim 3, wherein:
on a moving image screen which is synthesized into one by the image processor, a heavy construction equipment image is positioned in the middle and the data acquired from the plurality of cameras displayed around the heavy construction equipment image.

8. The running information recording device for heavy construction equipment of claim 4, wherein:
the synthetic moving image, which is synthesized in the image processor, includes GPS data, and posture information of the unit of heavy construction equipment acquired from the vehicle control apparatus.

9. The running information recording device for heavy construction equipment of claim 3, wherein:
the operating apparatus includes a working system operating apparatus for operating the operating apparatus of the unit of heavy construction equipment, a travel system operating apparatus for controlling travelling of the unit of heavy construction equipment, and an RPM setting operation apparatus for controlling an engine RPM of the unit of heavy construction equipment, and
an image corresponding to a change in an operational amount of at least one of the working system operating apparatus, the travel system operating apparatus, and the RPM setting operation apparatus is synthesized with the synthetic moving image.

10. The running information recording device for heavy construction equipment of claim 3, further comprising:
a monitor installed in a driving room to display the synthetic moving image.
